(19) United States
(12) Patent Application Publication
(10) Pub. No.: US 2006/0046163 A1
(43) Pub. Date: Mar. 2, 2006

(54) Color filter and liquid crystal display device comprising such filter

(75) Inventors: Dirk Jan Broer, Eindhoven (NL); Hendrik De Koning, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.C.

(21) Appl. No.: 10/530,645

(22) PCT Filed: Sep. 26, 2003
(86) PCT No.: PCT/IB03/04256

§ 371 Date: Apr. 6, 2005

(30) Foreign Application Priority Data
Oct. 14, 2002 (NL) 1021643

(51) Int. Cl. G02F 1/1335; G02B 5/20

(52) U.S. Cl. 430/7; 349/106; 359/891

(57) ABSTRACT

A color filter includes first, second and third regions for providing polarized light of a first, for example red, a second for example green and a third for example blue color respectively. To provide polarized light, a region comprises an isotropic colorant for selectively transmitting the first, the second or the third color, a uniaxially ordered base material and a dichroic colorant aligned by the uniaxially ordered base material for absorbing light selectively transmitted by the isotropic colorant. In a liquid crystal display device comprising such a color filter a polarizer can be dispensed with resulting in a simpler, more cost effective and robust display device.

The invention relates to a color filter and a liquid crystal display device comprising such a color filter.

Color filters are used in, for example, full-color liquid crystal displays (LCDs). A full-color LCD comprising a color filter is disclosed in U.S. Pat. No. 5,096,520. The LCD disclosed therein has a display cell which comprises individually addressable pixels. In order to provide full-color functionality the LCD includes a color filter having red, green and blue colored regions arranged opposite the pixels. To make the electro-optical effect brought about by switching the pixels visible to a viewer, the display includes two polarizers. One of the polarizers is arranged on the outside of the display. Since polarizers are easily damaged when exposed to the ambient, the polarizer on the outside renders the display susceptible to wear, mechanical contact and environmental aging. Polarizers are also expensive and contribute significantly to the display thickness.

It is an object of the invention to take away or at least partially take away the above-mentioned disadvantages. Specifically it is object of the invention, inter alia, to provide a color filter which, if used in a liquid crystal display, results in a liquid crystal display which has a simple construction, is thin and cost-effective to manufacture. Furthermore, use of the color filter for a display may result in a display which is more resistant to wear, mechanical contact and environmental aging.

This object is achieved by a color filter, more particular a polarization—selective color filter including a first, a second and a third region positioned adjacent to one another,
the first region comprising a first uniaxially ordered base material, a first isotropic colorant adapted to selectively transmit light of a first color in response to light being incident on the filter and a first dichroic colorant uniaxially aligned by the first base material and adapted to absorb light of the first color,
the second region comprising a second uniaxially ordered base material, a second isotropic colorant adapted to selectively transmit light of a second color in response to light being incident on the filter and a second dichroic colorant uniaxially aligned by the second base material and adapted to absorb light of the second color, and
the third region comprising a third uniaxially ordered base material, a third isotropic colorant adapted to selectively transmit light of a third color in response to light being incident on the filter and a third dichroic colorant uniaxially aligned by the third base material and adapted to absorb light of the third color.

The color filter in accordance with the invention is polarization-selective, that is the color filter provides, on the one hand, the functionality of filtering light to produce the desired first, second and third colors and, on the other hand, the generation of polarized light from unpolarized light incident on the filter.

If the order is a planar uniaxially order, the polarization selectivity of the color filter is largest for light incident at angles normal to the light entry surface of the filter and decreases when the angle of incidence increases. If the order is homeotropic uniaxial, no polarization selectivity occurs for normally incident light and the polarization-selectivity increases if the angle of incidence increases (angle measured from normal of the light entry surface). The term “planar” in “planar uniaxially ordered” means that the director of the uniaxial order is parallel or, if appropriate, locally parallel to a light-entry surface of the color filter, whereas the term homeotropic means that the director is perpendicular or, if appropriate, locally perpendicular to a light entry surface of the color filter. Generally, the color filter is provided in the form of a layer in which case one of its major surfaces is an entry surface.

In the prior art liquid crystal display color filtering and polarizing are performed by separate components, viz. the color filter and the polarizer. Accordingly, the polarization-selective color filter in accordance with the invention, if used in a liquid crystal display, results in a liquid crystal display of simplified construction in that it contains less components because one polarizer can be dispensed with. Having one polarizer less is also cost-efficient and, because polarizers contribute significantly to the thickness of the display, results in a display which is significantly thinner.

Arranging the color filter in accordance with the invention on the inside of a liquid crystal display cell the display is made more resistant to wear, mechanical contact and environmental aging because the polarizer which can be dispensed with is generally arranged on the outside of the liquid crystal display cell whereas the color filter is positioned on the inside thereof. As stated above, polarizers are vulnerable components which are easily damaged by wear and mechanical contact and age under the influence of the environment. Integration of the polarizer functionality into the color filter as proposed in accordance with the present invention pulls the polarizer functionality inside the liquid crystal cell where it is protected by the substrates of the display cell and leaves the robust substrate material, typically glass, exposed to the ambient.

Furthermore, if provided as separate components, the polarizer and color filter each tend to be somewhat over-dimensioned, that is absorb too much light than strictly necessary. Consequently, by integrating the polarizer and color functionality in one component these functionalities may be optimized in unison so as to achieve an improved brightness. In operation, as light incident on the polarization-selective color filter passes through a region of the color filter, the isotropic colorant absorbs the light which does not contribute to the color to be selectively transmitted. In other words, the color of the light absorbed is complementary to the color of the light transmitted, the term “complementary” meaning here complementary with respect to the light incident on the filter as a reference point. Normally, pure white is taken as the reference point to express whether a color is complementary to another. Therefore, the definition of “complementary” in the context of the present invention and the more conventional definition coincide if light incident on the filter is pure white. Obviously, in order to be able to select the desired color, the color of the light to be selectively transmitted must be present as a component in the light incident on the filter. The term “isotropic” in isotropic colorant means that the light absorption of the isotropic colorant is polarization insensitive. The dichroic colorant in the polarization-selective color filter polarizes the light selectively transmitted by the isotropic colorant by absorbing the component having a polarization orthogonal to the polarization to be transmitted. More particular, the dichroic colorant selectively absorbs linearly polarized light. The combined effect of the isotropic and the dichroic colorant is to provide polarized light of a desired color, that is a first, second or third color depending on the region considered.

The dichroic colorant polarization-selectively absorbs light because it is uniaxially aligned by the base material. As is well known in the art the characterizing feature of a dichroic colorant compared to a non-dichroic (isotropic) colorant is that its absorption spectrum is polarization selective in that only light of which the electric field vector is aligned with the transition dipole moment of the absorption of the chromophore of the dichroic colorant is absorbed. However, such polarization selectivity is only observed if the molecules or particles or more specifically the transition dipole moments of the colorant are more or less aligned in the same direction. If the orientation of the dichroic molecules or particles is random no polarization selection occurs.

A polarization-selective color filter for use in a liquid crystal display is known per se, see e.g. WO 99/42896 and the English-language abstract JP 10-300932. The color filter of WO 99/42896, which is silent with respect to a uniaxially ordered base material and dichroic colorants aligned thereby, is impressed on a glass plate using e-bean irradiation. E-beam irradiation is expensive and elaborate. JP 10-300932 is silent with respect to a color filter with a dichroic colorant which is aligned by a uniaxially ordered base material.

In a particular embodiment of the invention, the base material of a region is a liquid crystal rendering the color filter electrically switchable. Rendering the color filter electrically switchable allows the color filter to be an active light modulating component for example of a display. A display comprising such color filter has less polarizers than a conventional display thus resulting in a simpler, thinner and more cost-effective display.

A particular embodiment of such a switchable color filter comprises liquid crystal capable of being switched between a (locally) planar uniaxially ordered state which includes a twisted or super twisted uniaxially ordered state and a homeotropically ordered state, liquid crystal. In the planar uniaxially oriented state, the switchable color filter in accordance with the invention is polarization-selective and accordingly only a single linear absorbing polarizer, the absorption axis of which is aligned with the planar uniaxial order of the liquid crystal and dichroic colorant is required to obtain a dark state. A more particular embodiment of such switchable color filter comprises a region (pixel) including, as base material, an anisotropic gel comprising a uniaxially ordered liquid crystal and a homeotropically ordered polymeric network of cross-linked liquid crystal which is immersed in the liquid crystal throughout the gel, an isotropic colorant and a dichroic colorant which is aligned by the uniaxially ordered liquid crystal. Anisotropic gels are known are such, see e.g. U.S. Pat. No. 5,188,760. A display comprising such color filter according has the distinct advantage of requiring no polarizers thus rendering such display thinner, simpler and more robust.

In a preferred embodiment, the color filter is a filter for filtering white light and the first, the second and the third color is a red, a green and a blue color respectively. Although in principle there is no restriction on the choice of first, second and third color, and on the color which the color filter is supposed to filter, many applications, full-color liquid crystal displays being an example, require the filter to operate with white light as input and use red, green and blue as the colors to be selectively transmitted. By varying the amount of light transmitted in the red, green and blue regions any color within the color triangle spanned by the red green and blue color can be made when the separate light beams are perceived as blended by the human eye, such blending being easily facilitated by using red green and blue regions which have a size so small that the human eye cannot resolve them. In an alternative embodiment of a color filter for filtering white light the first, the second and the third color is a cyan, a magenta and a yellow color respectively. Such a color filter may be particularly useful for displays which are to provide a high brightness such as a projection display.

It may be beneficial in terms of display performance to use more than three regions. Therefore, a particular embodiment relates a color filter including a fourth region comprising a fourth uniaxially ordered base material, a fourth isotropic colorant adapted to selectively transmit light of a fourth color in response to light being incident on the filter and a fourth dichroic colorant uniaxially aligned by the fourth base material and adapted to absorb light of the fourth color. An example is the use of a separate black region in the cyan, magenta, yellow color filter to obtain a CMYK color scheme.

In a preferred embodiment, the first and/or the second and/or the third and/or, if present, the fourth base material are one and the same material. Although in principle the base material for the first, second and third and if present the fourth region may be different, which is advantageous as it provides more freedom to optimize the alignment of the dichroic colorants and dispersion of the isotropic colorants, the manufacture of the color filter becomes more simple if the same base material is used in each region. In particular, using one and the same material opens the possibility of providing the base material of the first, second and third region in one deposition step.

A particular embodiment of the color filter in accordance with the invention comprises a liquid crystal or a polymeric base material.

The base material is provided in a uniaxially ordered state so as to be capable of aligning the dichroic dye. The term “uniaxial” includes “biaxial”. Such base materials are known in the art as such, prime examples being liquid crystals, nematic liquid crystals in particular, and uniaxially ordered polymers. Use of liquid crystals allow a dynamic, that is electrically switchable, color filter to be constructed. Uniaxially ordered polymers obtained by stretching may be used, known in the art per se, or polymers obtained from (photo)-polymerizable or (photo-)cross-linkable liquid crystal compositions, also known in the art per se. Another particular embodiment of the color filter in accordance with the invention is one wherein an isotropic and/or a dichroic colorant is a dye or a pigment. There is no particular limitation on the isotropic and dichroic colorants which can be suitable used, the choice being dependent in particular on the desired colors of the regions on the one hand and the spectrum of the light incident on the filter for which the color filter is desired to be operative on the other hand.

Dyes and pigments which are used in conventional absorptive color filters can be suitably used as isotropic colorants. The isotropic colorant may be organic or inorganic. In particular, the isotropic colorant may be a dichroic colorant which is randomly ordered in the base material.

A colorant, isotropic and/or dichroic, may consist of one light absorbing compound but also a combination of light absorbing compounds may be used to suit particular absorption requirements. For example, if a colorant is to selectively transmit red light when white light is incident thereon, a combination of a green light absorbing and a blue light absorbing compound can be used.

The dichroic colorant may be a pigment of which the individual particles have an absorption which is polarization selective. By uniaxially ordering the pigment particles in the base material, which is for example conveniently facilitated if the individual particles have an oblong shape, the transition moments of the absorption become aligned in the same direction to achieve polarization-selective absorption. A example of such a combination of base material and dichroic colorant is provided in Dirix et al in INSPEC AN 6670199. Alternatively, the dichroic colorant may be a dye of which the individual molecules are dispersed in the base material, the individual molecules having a chromophore having an absorption which is directionally dependent and thus polarization-selective. By uniaxially ordering the individual molecules more or less in the same direction which is conveniently achieved if the molecules have an oblong shape, the transition moments become aligned in the same direction to a provide a polarization-selective absorption. As most dyes have molecules which are at least non-spherical if not oblong in shape a wide selection of dichroic colorants which may be suitably used in the color filter in accordance with the invention is available. Suitable examples are disclosed U.S. Pat. No. 6,133,973.

A dichroic colorant may be dispersed in a region as molecules separate from the base material but may also be dispersed in a region as part of the molecules of the base material so as to make alignment easier. Accordingly, a particular embodiment a color filter in accordance with the invention includes a region wherein a dichroic colorant and a base material are combined into one uniaxially oriented dichroic base material adapted to absorb the color selectively transmitted by the isotropic colorant of said region. Preferably all regions of the first color and/or the second and/or the third color have this feature.

The absorption spectrum of a dichroic colorant may be tuned to match the transmission spectrum of an isotropic colorant as closely as possible (in other words, the dichroic colorant selectively absorbs the light the isotropic dye selectively transmits) but this is not essential, its bandwidth may be wider. The bandwidth of the dichroic colorant may be selected to be as wide as to cover the entire spectrum of the light the color filter is designed to filter. This has the advantage that for each region, first, second or third, the same dichroic colorant may be used. Therefore, in a particular embodiment the color filter in accordance with the invention is a color filter wherein the first, the second and the third region comprise a common dichroic colorant adapted to absorb the first, the second and the third color respectively.

In a preferred embodiment, the invention relates to a liquid crystal display cell comprising a first substrate, a second substrate and, disposed therebetween, a color filter in accordance with the invention. The color filter in accordance with the invention with the integrated polarizing function being located between and thus protected by the substrates results in a display cell which is less easily damaged than a polarizer arranged on the outside.

If the polarization contrast (efficiency) is found to be insufficient for a particular application, the color filter may be combined with a conventional linear absorbing polarizer to improve the polarization contrast. Since the light such conventional polarizer receives is already to a considerable extent polarized, a relatively thin polarizer can be used.

In a preferred embodiment of the display cell however, the polarizer is provided between the substrates. Such polarizers, also referred to in the art as in-cell polarizers, are known in the art per se. The combination of the color filter in accordance with the invention and such an in-cell polarizer is particularly advantageous because the polarization contrast of in-cell polarizers is in general low compared to conventional polarizers for use outside a display LCD cell.

Homeotropically aligned dichroic colorants may be used to improve the viewing angle dependency of conventional linear absorptive polarizers designed to operate optimally for normally incident light. Therefore, in a particular embodiment the invention relates to a combination of a color filter in accordance with the invention wherein at least the first, second and third base material is planar uniaxially ordered and a homeotropically ordered layer including a first, a second and a third region arranged opposite a first, a second and a third region of the color filter respectively,
the first region of the homeotropically ordered layer comprising a first homeotropically ordered base material and a first dichroic colorant homeotropically aligned by the first base material, the first dichroic colorant being identical to the first dichroic colorant of the first region of the color filter,
the second region of the homeotropically ordered layer comprising a second homeotropically ordered base material and a second dichroic colorant homeotropically aligned by the second base material, the second dichroic colorant being identical to the second dichroic colorant of the second region of the color filter,
the third region of the homeotropically ordered layer comprising a third homeotropically ordered base material and a third dichroic colorant homeotropically aligned by the third base material, the third dichroic colorant being identical to the third dichroic colorant of the third region of the color filter.

Applications of the color filter may be found in fields as diverse as displays, photography and lighting. The color filter is of particular use in a liquid crystal display device to achieve full-color capability. The invention therefore relates in particular to a liquid crystal display device comprising a color filter in accordance with the invention. More particular, it relates to a liquid crystal display device comprising a display cell having a first and a second substrate between a color filter in accordance with the invention is provided. The display comprising the color filter may be a transmissive display, a reflective display or a transflective display.

Now that the inventors have disclosed their invention herein, those skilled in the art will appreciate that depending on the application, it may not be not necessary that the color filter has distinct first, second and third regions, any other number of regions may provide color filters useful in other arts than full-color displays.

Accordingly, in a broad sense the invention relates to a polarization-selective color filter for filtering light incident thereon including at least one region comprising a uniaxially ordered base material, an isotropic colorant adapted to selectively transmit light of a first color from the light incident on the filter and a dichroic colorant uniaxially aligned by the base material and adapted to absorb light of the first color.

These and other aspects of the invention will be apparent from and further elucidated with reference to the drawings and the examples described hereinafter.

In the drawings:

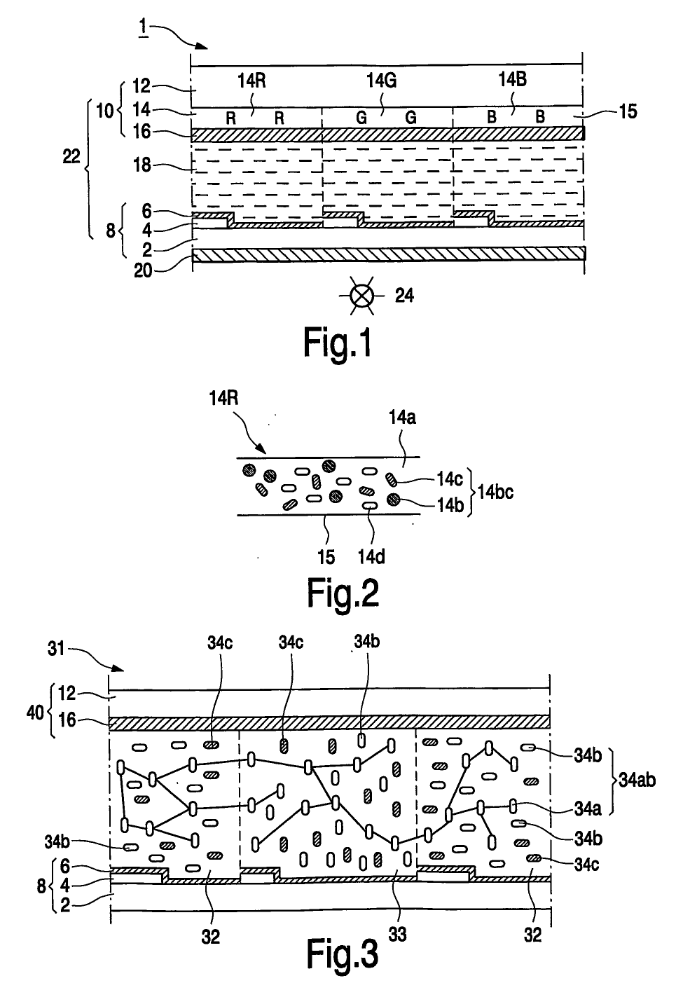

FIG. 1 shows, schematically, in a cross-sectional view, a full-color liquid crystal display device comprising a color filter in accordance with the invention,

FIG. 2 shows, schematically, in a cross-sectional view, a region of the color filter in accordance with the invention, and

FIG. 3 shows, schematically, in a cross-sectional view, an electrically switchable color filter in accordance with the invention.

FIG. 1 shows, schematically, in a cross-sectional view, a liquid crystal display device, more particular, a transmissive active matrix full-color liquid crystal display device comprising a color filter in accordance with the invention.

The display 1 comprises an active plate 8 including a first transparent substrate 2 made of glass, synthetic resin or other suitable material, active switching elements 4 comprising transparent electrodes 6 made of for example indium tin oxide (ITO) for switching individual pixels of the display. A passive plate 10 comprises a transparent substrate 12, a polarization-selective color filter in accordance with the invention 14 and a transparent counter electrode 16. Sandwiched between the active plate 8 and the passive plate 10 a (super) twisted nematic liquid crystal layer 18 is provided. The type of liquid crystal layer or liquid crystal effect is not essential to the invention as long as the electro-optical effect associated with the LC layer 18 requires the use of the polarization selectivity provided by the color filter in accordance with the invention. To obtain the twisted nematic orientation of the LC layer 18 alignment layers are used which are, for reasons of clarity, not shown in FIG. 1. The type of LC effect used and the LC material used is conventional.

The active matrix switching elements 4 allow the electrodes 6 to be individually addressable. Each electrode 6 is capable of switching the part of the LC layer 18 adjacent to it thus obtaining a display having individually addressable pixels.

In order to make the effect of switching of the LC layer 18 visible to a viewer the display 1 comprises a (linear, absorptive) polarizer 20 which in this embodiment is included in the active plate 8. The polarizer 20 may be a conventional polarizer arranged on the outside of the display cell 22 but it may also be arranged on the inside thereof that is between the substrates 12 and 4. A second polarizing means is integrated in the polarization-selective color filter 14. In the present example, since a twisted nematic LC layer 18 is used, the transmission axis of the polarizer 20 and the transmission axis of the color filter 14 are at right angles to each other.

Alternatively, the polarizer 20 may be arranged on the passive plate 10 and the color filter 14 on the active plate 8.

The polarization-selective color filter 14 has, opposite to each of the electrodes 6, first regions 14R for selectively transmitting red light, second regions 14G for selectively transmitting green light and third regions 14B for selectively transmitting blue light. The regions are grouped to form an array of RGB triplets each triplet consisting of a region 14R, 14G and 14B (not shown in FIG. 2).

The number of differently colored regions is not necessarily three, depending on the particular application of the color filter it may be less or more. For example, if by blending the light originating from the red green and blue regions a satisfactory pure white is not available a fourth region which is transparent and does not absorb any of the light incident on it may be included in the color filter. Also, a black region laid out as a matrix surrounding the regions arranged opposite the electrodes may be provided to improve contrast. In the present embodiment it is envisaged that all regions have a uniaxially alignment in the same direction. However this is not essential. In particular if sub-pixelation is employed to optimize for example viewing angle dependency it may of interest to have the direction of alignment be different from one sub-pixel to another and accordingly to have sub-regions having a direction of uniaxial alignment coinciding with the alignment of the sub-pixels.

In the present embodiment red green and blue regions are used to obtain full-color functionality and the filter 14 is designed to filter white light. Other color schemes are possible as well, for example the well known cyan magenta yellow (CMY) or cyan magenta yellow black (CMYK) scheme. Obviously, by suitable choice of the colorants the color filter can be made to be operative for any other part of the visible spectrum. Even the infrared or ultraviolet regions of the spectrum can be used.

The thickness of the color filter is typically 50 nm to 100 μm, more particular, 100 nm to 10 μm. The thickness of the film is selected in accordance with the absorbing power of the colorants.

In operation, white light from the light source 24 is polarized by the polarizer 20 to produce linearly polarized light. In the off-state of a pixel, that is with no voltage applied to the pixel, the polarization of the light is rotated by the LC layer 18 by 90° or an odd multiple thereof. The transmission axis of the color filter 14 being at right angles to the transmission axis of the polarizer 20, the light is transmitted by the color filter and filtered to produce the desired color while leaving the polarization unchanged. On the other hand, in the ON state of a pixel, the LC layer 18 does not rotate the polarization of the light incident thereon and is therefore absorbed in the region of the color filter 14 corresponding to the pixel.

FIG. 2 shows, schematically, in a cross-sectional view, a region of the color filter in accordance with the invention.

A region of the color filter 14 (by way of example a region 14R is shown in FIG. 2) comprises a base material 14a, a first isotropic light absorbing substance 14b, a second isotropic light absorbing substance 14c, the first and second light absorbing substance together forming the isotropic colorant 14bc and a dichroic colorant 14d.

In the present embodiment the base material 14a is envisaged to be a solid, in particular a polymer. This is not essential however, a liquid in particular a liquid crystal base material may also be used which is of particular use if the color filter is to be switchable.

The base material has the function of enabling the homogeneous dispersion of the isotropic and dichroic colorant in the region. The base material has the further function of bringing about uniaxial alignment of the dichroic colorant dispersed in such base material. In order to provide that functionality the base material 14a is uniaxially ordered. In the color filter shown in FIGS. 1 and 2, the base material is planar uniaxially ordered that is the uniaxial axis extends substantial parallel to the light-entry surface 15. By planar uniaxially ordering the base material and thus the dichroic colorant, polarization-selection is optimal for normally incident light, polarization-selectivity becoming less if the angle of incidence increases (angle measured from the normal). Alternatively, the uniaxial order may be homeotropic resulting in the dichroic colorant being oriented at right angles to the light-entry surface 15. The dichroic colorant being so ordered, polarization selection is worst at normal incidence and becomes better as the angle of incidence increases.

Base materials capable of being brought into and sustain a uniaxially ordered state, so as to be capable of aligning the dichroic dye are known in the art as such, prime examples being liquid crystals, nematic liquid crystals in particular and uniaxially ordered polymers. Uniaxially ordered polymers obtained by stretching may be used. Such polymers are known in the art per se. Examples includes stretched polyethylene, poly-ethylenenaphthalene (PEN), polyvinylalcohol and polyethyleneterephthalate, and other polymers such as those disclosed in U.S. Pat. No. 6,133,973.

Polymers obtained from (photo-)polymerizable and/or (photo-)cross-linkable liquid crystal compositions may also be used to obtain a uniaxially ordered polymer. Such polymers are known in the art per se, see e.g. WO 88/000227. Examples of polymerizable and/or crosslinkable liquid crystals are mesogenic substances provided with one or more polymerizable groups such as (meth)acrylate, vinylether, vinyl, oxetane or epoxide groups. A thiol-ene (system) may also be used. Cross-linkable liquid crystal compositions are particularly attractive if the differently colored regions of the color filter are deposited in separate successive steps because a previously deposited cross-linked region improves resistance in particular solvent resistance to the processing required for depositing a further region.

The content of the base material in the region is typically not more than 95% by weight, in particular not more than 90% by weight. It is preferably present in an amount ranging from about 20% to about 90% based on the weight of the solids in the layer. A more preferred range is from about 30% to about 70% and most preferably from about 35% to about 65%.

Although in principle the base material for the first, second and third and if present the fourth region may be different, for example, to optimize the alignment of the dichroic colorants and dispersion of the isotropic colorants, the manufacture of the color filter becomes more simple if the same base material is used in each region. In particular, using one and the same material opens the possibility of providing the base material of the first, second and third region in one deposition step.

The region 14R of the color filter in accordance with the invention comprises an isotropic colorant. In the context of the invention isotropic means that the color of the light which is selectively transmitted does not depend on the polarization direction of the incident light. More particular, the color is independent within the range of angles at which the light to be filtered is incident on the filter. A colorant may consist of a single type of light absorbing substance but it may also comprise—as shown in FIG. 2—a plurality of light absorbing substances.

Isotropic colorants are well known in the art. In particular, colorants conventionally used in absorptive color filters for liquid crystal displays may be suitably used in color filters in accordance with the invention.

The colorant may be a pigment comprised of individual pigment particles or it may be a dye which comprised of individual molecules. The colorant may be organic or inorganic. The individual pigment particles or individual dye molecules are homogeneously dispersed in the base material. In order to provide a directionally independent color the colorant must be dispersed isotropically in the base material. As shown by isotropic colorant 14b in FIG. 2, this may be achieved by means of using a colorant of which the particles or molecules are more or less spherical. There are not many dye molecules known in the art which are spherical but pigment particles often are more or less spherical in the sense of not having a preferred direction. Alternatively or most likely additionally, a colorant having asymmetrically shaped molecules or particles may be used provided the individual dye molecules or pigment particles are dispersed in random orientation within the base material as shown by isotropic light absorbing substance 14c in FIG. 2. In case a pigment is selected the particle size is preferably small, say less than a 100 nm, so as not to disturb the orientation of the liquid crystalline host substantially.

In FIG. 2 two separate isotropic colorants 14b and 14c are used providing the combined effect of selectively transmitting red light. For example, isotropic colorant 14b may absorb green light while isotropic colorant 14c absorbs the blue part of the white light incident on the display. However, a single isotropic colorant comprising two chromophores, one for green and one for blue, or a single broadband chromophore may also be used. Alternatively, the isotropic colorant may be integrated with the base material to form an isotropic uniaxially ordered base material which selectively transmits light of a desired color. This may be realized by covalently bonding base material molecules to isotropic dye molecules.

A few commercially available non-exclusive examples of isotropic colorants usable in the present invention are: Benzidine Yellow G (C.I. 21090), Benzidine Yellow Gr (C.I. 21100), Permanent Yellow DHG (product of Hoechst AG), Brilliant Carmine 6B (C.I. 15850), Rhodamine 6G Lake (C.I. 45160), Rhodamine B Lake (C.I. 45170), Phthalocyanine Blue non-crystal (C.I. 74160), phthalocyanine Green (C.I. 74260), Carbon Black, Fat Yellow 5G, Fat Yellow 3G, Fat Red G, Fat Red HRR, Fat Red SB, Fat Black HB, Zapon Fast Black RE, Zapon Fast Black G, Zapon Fast Blue HFL, Zapon Fast Red BB, Zapon Fast Red GE, Zapon Fast Yellow G, quinacridone Red (C. I. 46500).

The isotropic colorant is preferably present in an amount sufficient to uniformly color the region of the color filter. It is preferably present in an amount ranging from about 5% to about 50% based on the weight of the solids in the layer. A more preferred range is from about 10% to about 40% and most preferably from about 15% to about 35%.

Regions of the color filter in accordance with the invention comprise a dichroic colorant, in particular a dichroic colorant which is uniaxially aligned by the base material. In FIG. 2 the dichroic colorant 14e absorbs red light. More in particular, because the dichroic colorant 14e is uniaxially oriented the absorption is polarization-selective.

In FIG. 2 just one dye or pigment is used but in general the dichroic colorant may comprise a plurality of dyes and/or pigments.

The dichroic colorant may be a pigment of which the individual particles have an absorption which is polarization selective. By uniaxially ordering the pigment particles in the base material, which is conveniently facilitated if the individual particles have an oblong shape, the transition moments of the absorption become aligned in the same direction to achieve polarization-selective absorption. An example is provided in Dirix et al in INSPEC AN 6670199.

Alternatively, the dichroic colorant may be a dye of which the individual molecules are homogeneously dispersed in the base material, the individual molecules having a chromophore having an absorption which is directionally dependent and thus polarization-selective. By uniaxially ordering the individual molecules in the same direction, which is conveniently achieved if the molecules have an oblong shape, the transition moments become aligned in the same direction to provide a polarization-selective absorption. As most dyes have molecules which are at least non-spherical if not oblong in shape and therefore an absorption having a transition moment which is directionally dependent, a wide selection of dichroic colorants is available. Suitable examples are disclosed U.S. Pat. No. 6,133,973. A particularly suitable dichroic dye has the formula

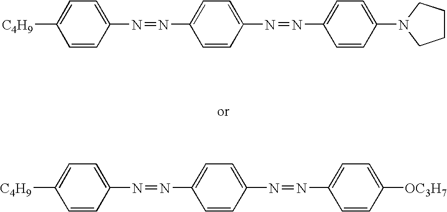

The dichroic colorant is preferably present in an amount sufficient to absorb one polarization component of the light selectively transmitted by the isotropic colorant. It is preferably present in an amount ranging from about 5% to about 50% based on the weight of the solids in the layer. A more preferred range is from about 10% to about 40% and most preferably from about 15% to about 35%.

The dichroic colorant may be dispersed as molecules separate from the base material but may also be part of the molecules of the base material which may make alignment easier and reduces the number of components a region of the color filter is made of. Integration of the dichroic colorant and base material may be achieved by means of for example covalent bonding of a dichroic dye molecule to a molecule of the base material to form a uniaxially ordered dichroic base material.

The absorption spectrum of the dichroic colorant may be tuned to match the transmission spectrum of the isotropic colorants as close as possible (in other words, selectively absorbs the light the isotropic dye selectively transmits) but this is not essential, its bandwidth may be wider. The bandwidth of the dichroic colorant may be selected to be as wide as to cover the entire spectrum of the light the color filter is designed to filter. This has the advantage that for each region, first, second or third, the same dichroic colorant may be used. Preferred therefore is a color filter wherein the first, the second and the third region comprise a common dichroic colorant adapted to absorb the first, the second and the third color respectively.

The combined effect of the isotropic and dichroic colorant shown in FIG. 2 is to provide polarized red light. In a similar manner regions providing green and blue colored polarized light respectively may be provided.

The filter shown in FIG. 1 includes regions which provide red, green and blue-colored light respectively. Alternatively, a polarization-selective color filter including a cyan (C), magenta (M) and yellow (Y) regions may be used. Such a CMY filter may be for example formed by means of a first region comprising a red isotropic colorant and a green and a blue dichroic colorant, a second region comprising a green isotropic colorant and a dichroic red and blue colorant and a third region comprising a blue isotropic colorant and a red and green dichroic colorant.

Various methods are available for manufacturing the color filter in accordance with the invention.

In a first method, on a suitable substrate, first, second and third regions are formed by successive first, second and third patterning steps, the first, second and third patterning step involving the deposition of a film-forming composition comprising a base material, an isotropic colorant and a dichroic colorant, uniaxially orienting the base material and thus the dichroic colorant in the film-forming composition so deposited, and if present removing one or more components added to enable film-formation, such as solvent, from the film-forming composition so deposited to form the first the second or the third region.

The colorants and base materials may also be deposited in separate steps. Accordingly, a second method comprises depositing on a suitable substrate, a layer of uniaxially ordered base material, the layer being continuous or patterned to comprise a plurality of distinct regions and then make the first, second and third isotropic and dichroic colorants diffuse into the layer of base material in successive patterning steps.

If a dichroic colorant common to all regions is used in the second method the dichroic colorant may be deposited together with base material.

The base material may be deposited directly in its final form, which is convenient if the base material is a liquid crystal, or a stretched polymer film. The base material may also be deposited in the form of a precursor which, after having been deposited, is converted to its final form. An example of such a precursor material is a (photo-)polymerizable or more particular (photo-)crosslinkable liquid crystal material which after having been uniaxially ordered is (photo-)polymerized or cross-linked to form a uniaxially ordered polymeric or crosslinked base material.

A colorant can be made to diffuse into the base material by exposing the deposited base material to the colorant vapor or a solution containing the colorant.

Suitable patterning methods to form first, second and third regions include photo-lithography or another method which allows temporary masking of the substrate in accordance with a desired pattern and printing methods such as ink jet printing, flexographic printing, micro-contact printing, offset printing, screen printing. The differently colored regions may be deposited in one patterned deposition step, for example by means of multi-nozzle inkjet printing, or may be deposited in successive patterning steps. If successive patterning steps are used the substrate and base material must be selected to be resistant to the successive patterning steps. A crosslinked base material may be used to achieve such resistance. Uniaxially orienting base material or a precursor material thereof may be by conventional means, such as an alignment layer, subjecting the base material to electric and/or magnetic fields or by mechanical means such as shear-induced orientation.

By way of example, the color filter 14 may be manufactured as follows: A glass substrate is coated with a polyimide alignment layer, for example by applying a thin film, e.g. 30 to 150 nm, of a precursor poly-imide (AL1051 commercially from Japan Synthetic Rubber) on the substrate by spin-coating, curing the film at 240° C. and buffing the cured film uniaxially with a velvet cloth to provide the film with planar uniaxial alignment capability. A liquid crystalline acrylate composition comprising the isotropic and dichroic colorant is then pattern-wise deposited on the substrate. Upon deposition, the polyimide alignment layer brings about uniaxial orientation of the liquid crystalline acrylate composition so deposited. The orientation adopted by the liquid crystal molecules is forced upon the dichroic colorant molecules or particles thus inducing uniaxial order of the dichroic colorant. Subsequently, in this uniaxially ordered state, the liquid crystalline acrylate composition is photo-polymerized while preserving the uniaxial order to provide the first region 14R of the color filter 14. This process is repeated two times in order to obtain the regions 14G and 14B. Onto the color filter thus obtained the ITO electrode layer 16 can be deposited by means of sputtering. To avoid damaging the substrate, it may be prudent to provide a thin film silicon dioxide on the color filter before sputtering. Optionally, to planarize the color filter, an additional film may be applied, e.g. consisting of acrylate monomers with a functionality greater than 2 such that a stable crosslinked film is obtained by UV curing in the presence of photoinitiator.

The polarization-selective color filter 14 of the liquid crystal display cell 22 is arranged between the substrates 4 and 12 and thus protected thereby. If the polarization contrast provided by the color filter is deemed to be insufficient for a particular application, the color filter may be combined with a polarizer to improve the polarization contrast. Since the color filter provides polarized light, the thickness of the polarizer can be reduced thus reducing the thickness of the display. Preferably, the polarizer is also provided between the substrate that is on the inside of the cell 22.

The combination of the color filter in accordance with the invention and such an in-cell polarizer is advantageous because it is in general difficult for inside-polarizers to attain the polarization contrast of conventional sheet polarizers. If the in-cell polarizer is combined with a polarization-selective color filter the desired polarization contrast (that is ratio of polarization to be transmitted and polarization to be absorbed) may be achieved while at the same time reducing the thickness of the in-cell polarizer and/or the color filter. The combination of color filter and in-cell polarizer being arranged on the inside of the display cell, renders the display cell resistant to wear, mechanical contact and environmental aging. Polarizers which can be suitably used as in-cell polarizer are known in the art per se. For example, the coatable polarizers disclosed in WO 02/42832 may be used as in-cell polarizer as well as those disclosed in U.S. Pat. No. 6,049,428. The thickness of such polarizers is typically about 200 nm to about 2 μm. The color filter 14 of the display shown in FIG. 1 has a planar uniaxially order and consequently works best if light incident on the regions of the color filter is incident at normal angles. Assuming the transition moment of the absorption of the dichroic colorant coincides with the direction of uniaxial alignment (which is typically the case at least if oblong shaped colorant molecules or particles are used) the dichroic colorant does not absorb any light propagating in the direction of uniaxial alignment. Consequently, if light is incident on the color filter at an angle such that, if decomposed into components, it has a component propagating in the direction of uniaxial alignment polarization selection does not take place for such component with the net result that for such off-normal angles the polarization contrast is less than for light incident at normal angles.

In order to improve the performance of the color filter in accordance with the invention for off-normal incident light, the color filter may be combined with a layer comprising a dichroic colorant which is aligned in a direction normal to the region of the color filter of which the performance is to be improved. Such alignment is also referred to in the art as a homeotropic alignment. Therefore, the viewing angle dependency of the polarization contrast of a color filter having at least a first, second and third base material which is planar uniaxially ordered is improved if combined with a homeotropically ordered layer including a first, a second and a third region arranged opposite a first, a second and a third region of the color filter respectively,
the first region of the homeotropically ordered layer comprising a first homeotropically ordered base material and a first dichroic colorant homeotropically aligned by the first base material, the first dichroic colorant being identical to the first dichroic colorant of the first region of the color filter,
the second region of the homeotropically ordered layer comprising a second homeotropically ordered base material and a second dichroic colorant homeotropically aligned by the second base material, the second dichroic colorant being identical to the second dichroic colorant of the second region of the color filter,
the third region of the homeotropically ordered layer comprising a third homeotropically ordered base material and a third dichroic colorant homeotropically aligned by the third base material, the third dichroic colorant being identical to the third dichroic colorant of the third region of the color filter. Preferably the homeotropically ordered layer is provided adjacent the color filter and accordingly on the inside of a display cell.

Homeotropically ordered layers, more particularly homeotropically ordered layers comprising dichroic dyes which are homeotropically aligned are known in the art per se, see eg EP 608924 and may be used effectively in combination with the color filter in accordance with the invention.

The full-color liquid crystal display 1 shown in FIG. 1 is an active matrix display, but this is not essential, the color filter in accordance with the invention may also be used in a passive matrix display or even a segmented display.

The display 1 is a transmissive display, however the invention is equally applicable to a reflective or a transflective liquid crystal display.

A first embodiment of a reflective liquid crystal display comprises, in succession, a polarization-selective color filter in accordance with the invention to provide linear polarized light, a combination of a retardation layer and a liquid crystal layer, the combination adapted for switching between a state having a quarter wavelength retardation or odd multiple thereof and a state of zero or half wavelength retardation or an multiple thereof, and a light reflective surface for converting the handedness of circularly polarized light incident thereon upon reflection. The color filter polarizes and filters ambient light and analyzes the linearly polarized reflected light. This first embodiment is attractive in that it comprises no polarizers, the required polarizing functionality being included in the color filter. Moreover, if the liquid crystal layer is sandwiched between a first and a second substrate, the first being arranged on the viewing side of the liquid crystal, the color filter may be provided between the first substrate and the liquid crystal layer or preferably on the first substrate thus improving the robustness of the display.

A second embodiment of a reflective liquid crystal display comprises, in succession, a linear absorbing polarizer, a liquid crystal layer for switching linear polarized light, a color filter selective for linear polarized light in accordance with the invention and a light reflective surface. Advantage of this second embodiment is that in order to provide bright and dark states no retardation layers are required, such layers being generally relatively thick and expensive, and further that a wide variety of LC effects is available such as (super)twisted nematic, in-plane switching or any other LC effect capable of switching between zero or a half λ retardation or any odd multiple thereof. The color filter is of particular use in a transflective display. An embodiment of such a transflective display comprises, in succession, a linear absorbing polarizer, a liquid crystal layer for switching linear polarized light, a color filter providing linear polarized light in accordance with the invention and a light reflector, the transflector, which is patterned to provide reflective regions and transparent regions, reflective regions and transparent regions being grouped to correspond to individually addressable pixels having a reflective region for operating the display with ambient light and a transparent region for operating the display in transmission with light from a back light. In reflection, the display operates in the same manner as the reflective display described above and in transmission the display operates as the transmissive display 1 of FIG. 1. The advantage of this transflective display is that it does not require retarders and the LC layer is a common one such as (super) twisted nematic.

The color filter of FIGS. 1 and 2 is a static optical component in that its functionality does not change upon subjecting the color filter to an electric field. However the invention is not limited to such color filters. The invention also relates to electro-optical color filters the filtering properties of which can be altered by subjecting the filter to an electric field. Rendering the color filter electrically switchable allows the color filter to be an active light modulating component for example of a display. A display comprising such color filter has less polarizers than a conventional display thus resulting in a simpler, thinner and more cost-effective display.

Such an electrically switchable color filter may be realized by using a liquid crystal base material. In a particular embodiment of the invention, the base material of a region is a liquid crystal rendering the color filter electrically switchable. Liquid crystals which can be electrically switched and electro-optical effects which may be achieved using such liquid crystals are well known in the art.

A particular embodiment of such a switchable color filter comprises liquid crystal capable of being switched between a planar uniaxially ordered state, which may a locally planar uniaxially ordered state such as a twisted or super twisted liquid crystal state, and a homeotropically ordered state. In the planar uniaxially oriented state, the switchable color filter in accordance with the invention is polarization-selective for normally incident light. In order to obtain a dark state the color filter is combined with a single linear absorbing polarizer, the absorption axis of which is aligned with the planar uniaxial order of the liquid crystal and dichroic colorant. When the liquid crystal is switched to the homeotropically ordered state the dichroic colorant dispersed therein is forced to adopt a homeotropic order as well and therefore is not capable of absorbing light propagating in the normal direction. The color filter then transmits unpolarized light. Only one component of this unpolarized light is absorbed in the linear polarizer resulting in a bright state of the desired color.

FIG. 3 shows, schematically, in a cross-sectional view, an electrically switchable color filter in accordance with the invention. The more particular embodiment of the switchable color filter 31 comprises regions or pixels 32 and 33 of which the base material is an anisotropic gel 34ab comprising a homeotropically ordered liquid crystal 34b and a homeotropically ordered polymeric network 34a of cross-linked liquid crystal which is immersed in the liquid crystal 34b throughout the gel 34ab and of which the dichroic colorant 34c is aligned by the ordered liquid crystal 34b. Anisotropic gels are known are such, see eg U.S. Pat. No. 5,188,760. The gel further comprises an isotropic colorant but for reasons of clarity the isotropic colorant is not shown in FIG. 3. Isotropic and dichroic colorants described above as being suitable for static color filters can also be suitably used for electrically switchable color filters. If the dichroic colorant 34c, the network 34a and liquid crystal 34b are all homeotropically ordered, such as shown in pixel 33, the pixel of the color filter appears bright and presents the color selectively transmitted by the isotropic colorant. As shown in the pixels 32, upon applying a suitable electric field the liquid crystal molecules 34b become planar uniaxially ordered and with it the dichroic colorant 34c while the homeotropic order of the polymeric network 34a is maintained with the result that the color filter scatters light incident thereon. To enable such switching from a homeotropic to a planar uniaxial state, liquid crystals having negative dielectric anisotropy, which are as such known in the art, may be used. The scattering has the effect that both polarization directions of the incident light are eventually absorbed by the planar uniaxially ordered dichroic colorant 34c as scattering events cause depolarization, resulting in a dark state. The electrically switchable color filter according to this embodiment has the distinct advantage of requiring no polarizers thus rendering a display comprising such filter thinner, simpler and more robust. In summary, the invention relates to a -selective color filter which includes first, second and third regions for providing polarized light of a first, for example red, a second for example green and a third for example blue color respectively. To this end a region comprises an isotropic colorant for selectively transmitting the first, second or third color, a uniaxially ordered base material and a dichroic colorant aligned by the uniaxially ordered base material for absorbing light of the selectively transmitted by the isotropic colorant. The ordered dichroic colorant renders the color filter polarization-selective. When the color filter is used in a liquid crystal display device, a polarizer can be left out thus resulting in a simpler, thinner, more cost-effective and, if the polarizer to be dispensed with is located outside of the display cell, a more robust display device. In a broader sense, the color filter does not have to include exactly three different types of region, any other number may be used as well if a particular application so demands.

1. A color filter including a first, a second and a third region positioned adjacent to one another,
the first region comprising a first uniaxially ordered base material, a first isotropic colorant adapted to selectively transmit light of a first color in response to light being incident on the filter and a first dichroic colorant uniaxially aligned by the first base material and adapted to absorb light of the first color,
the second region comprising a second uniaxially ordered base material, a second isotropic colorant adapted to selectively transmit light of a second color in response to light being incident on the filter and a second dichroic colorant uniaxially aligned by the second base material and adapted to absorb light of the second color, and
the third region comprising a third uniaxially ordered base material, a third isotropic colorant adapted to selectively transmit light of a third color in response to light being incident on the filter and a third dichroic colorant uniaxially aligned by the third base material and adapted to absorb light of the third color.

2. A color filter as claimed in claim 1 wherein the color filter is a filter for filtering white light and the first, the second and the third color is a red, a green and a blue color respectively.

3. A color filter as claimed in claim 2 wherein the color filter is a filter for filtering white light and the first, the second and the third color is a cyan, a magenta and a yellow color respectively.

4. A color filter as claimed in claim 1 including a fourth region comprising a fourth uniaxially ordered base material, a fourth isotropic colorant adapted to selectively transmit light of a fourth color in response to light being incident on the filter and a fourth dichroic colorant uniaxially aligned by the fourth base material and adapted to absorb light of the fourth color.

5. A color filter as claimed in claim 4 wherein the first and/or the second and/or the third and/or, if present, the fourth base material are one and the same material.

6. A color filter as claimed in claim 1 comprising a polymeric base material.

7. A color filter as claimed in claim 6 wherein an isotropic and/or a dichroic colorant is a dye or a pigment.

8. A color filter as claimed in any one of the preceding claims including a region wherein a dichroic colorant and a base material are combined into one uniaxially oriented dichroic base material adapted to absorb the color selectively transmitted by the isotropic colorant of said region.

9. A color filter as claimed in claim 1 wherein the first, the second and the third region comprise a common dichroic colorant adapted to absorb the first, the second and the third color respectively.

10. A liquid crystal display cell comprising a first substrate, a second substrate and, disposed therebetween, a combination of a color filter as claimed in claim in any one of the preceding claims and a polarizer.

11. A combination of a color filter as claimed in claim 1 wherein the base material is planar uniaxially ordered and a homeotropically ordered layer including a first, a second and a third region arranged opposite a first, a second and a third region of the color filter respectively,
the first region of the homeotropically ordered layer comprising a first homeotropically ordered base material and a first dichroic colorant homeotropically aligned by the first base material, the first dichroic colorant being identical to the first dichroic colorant of the first region of the color filter,
the second region of the homeotropically ordered layer comprising a second homeotropically ordered base material and a second dichroic colorant homeotropically aligned by the second base material, the second dichroic colorant being identical to the second dichroic colorant of the second region of the color filter,
the third region of the homeotropically ordered layer comprising a third homeotropically ordered base material and a third dichroic colorant homeotropically aligned by the third base material, the third dichroic colorant being identical to the third dichroic colorant of the third region of the color filter.

12. A color filter as claimed in claim 1 comprising a liquid crystal base material rendering the color filter electrically switchable.

13. A color filter as claimed in claim 12 comprising a region of which the base material is an anisotropic gel comprising a homeotropically ordered liquid crystal and a homeotropically ordered polymeric network of cross-linked liquid crystal which is immersed in the liquid crystal throughout the gel and of which the dichroic colorant is homeotropically aligned by the ordered liquid crystal.

14. A liquid crystal display device comprising a color filter as claimed in claim in claim 1.

15. A polarization-selective color filter for filtering light incident thereon including at least one region comprising a uniaxially ordered base material, an isotropic colorant adapted to selectively transmit light of a first color from the light incident on the filter and a dichroic colorant uniaxially aligned by the base material and adapted to absorb light of the first color.
